(19) United States
(12) Patent Application Publication
(10) Pub. No.: US 2004/0029591 A1
(43) Pub. Date: Feb. 12, 2004

(54) Method and apparatus for accommodating high bandwidth traffic on a wireless network

(75) Inventors: Peter William Chapman, Kanata (CA); Benedict Gerrard Bauer, Gloucester (CA); Ralph Thomas Carsten, Carp (CA)

Correspondence Address: JOHN C. GORECKI, ESQ., 165 HARVARD ST., NEWTON, MA, 02460, US

(73) Assignee: Nortel Networks Limited, St. Laurent (CA)

(21) Appl. No.: 10/324,908

(22) Filed: Dec. 20, 2002

Related U.S. Application Data
(60) Provisional application No. 60/401,846, filed on Aug. 7, 2002.

(51) Int. Cl. H04Q 7/20

(52) U.S. Cl. 455/452.1; 455/450

(57) ABSTRACT

A low data rate wireless channel (control channel) is associated with a high speed broadcast mode wireless channel (data channel). The data channel is divided into discrete code or time slots (access slots), that are unassigned to any particular recipient or user until requested. In the event that a particular user requires a particular resource, access slots are requested through the control channel, allocated to the user, and allocation information is passed back to the requesting user through the control channel. By diverting setup and control traffic to a low-bandwidth, always-on quasi real-time control channel, capacity on the data channel can be freed up to enable the high-speed data channel to be dedicated to transmission of high-bandwidth traffic. Thus, scarce high-bandwidth resources can be utilized to the full extent to reduce the probability of time slots not being utilized due to scheduling conflicts and without requiring transmissions to stop to perform housekeeping functions between transmissions.

### BACKGROUND OF THE INVENTION

1. Field of the Invention

The present invention relates to high bandwidth wireless communications and, more particularly, to a method and apparatus for enabling high bandwidth data transmissions over wireless communication networks.

2. Description of the Related Art

Wireless communication networks have been deployed in many areas. While these wireless communication networks have data rates sufficient to handle voice traffic, as higher bandwidth data centric applications are deployed and implemented, the existing deployed technology base is likely to be unable to accommodate the increased demand in bandwidth.

There are currently two basic technologies in use in second generation wireless communications networks. In Europe, parts of the United States, and most of the rest of the world, wireless transmissions are based on a technology referred to as Time Division Multiple Access (TDMA). TDMA divides an available channel into time slots and interleaves multiple digital signals onto a single high-speed channel. One popular wireless technology based on TDMA is referred to as Global System for Mobile Communications (GSM). GSM is a circuit-switched system that divides each 200 kHz channel into eight 25 kHz time slots.

In the United States and certain parts of Asia, wireless transmissions are based on a technology referred to as Code Division Multiple Access (CDMA), which is a method for transmitting simultaneous signals over a shared portion of the spectrum. Unlike TDMA, which divides the spectrum into different time slots, CDMA's spread spectrum technique overlaps every transmission on the same carrier frequency by assigning a unique code to each conversation. After the speech codec (coder-decoder) converts the analog voice signal to a digital signal, the CDMA system spreads the digital voice stream over the full 1.25 MHz bandwidth of a CDMA channel, coding each stream separately so it can be decoded at the receiving end. All voice conversations thus use the full bandwidth at the same time. One bit is multiplied into 128 coded bits by the spreading techniques, providing the receiving side with a large amount of data that can be averaged to determine the value of each bit when correlated with the appropriate code.

GSM and (Interim Standard) IS-95A (code name for CDMA wireless currently deployed in the United States) are both optimized for voice transmission. Voice transmission is characterized by transmission that requires a relatively constant regular amount of bandwidth, but which is not particularly bursty. GSM and IS-95A are not optimized, however, for data transmission which tends to be very bursty with a relatively low average data rate.

Several proposed transmission standards are in the process of being developed to enable wireless networks to be deployed that can accommodate higher bandwidth data transmissions as well as voice. In the TDMA-based wireless space, the evolving technology is Wideband CDMA (W-CDMA). W-CDMA is a third generation (3G) technology that increases data transmission rates in GSM systems by using a CDMA air interface instead of the TDMA interface. In the ITU's IMT-2000 3G specification, W-CDMA has become known as the Direct Sequence (DS) mode.

Universal Mobile Telecommunications System (UMTS) is the European implementation of W-CDMA that is planned to form the basis of the 3G wireless phone system in Europe. UMTS, which is part of IMT-2000, provides service in the 2 GHz band and offers global roaming and personalized features. The UMTS specification calls for support of multimedia data rates of up to 2 Mbps using the W-CDMA technology. In the meantime, General Packet Radio Service (GPRS), which modifies GSM to support data packets up to 114 Kbps, and Enhance Data Rates for Global Evolution (EDGE), which increases data throughput to 384 Kbps, are interim steps to speed up wireless data for GSM.

In the IS-95A CDMA space in use in the United States, the technology is evolving toward CDMA-2000, a 3G wireless technology that offers twice the voice capacity and data speed (up to 307 Kbps) on a single 1.25 MHz (1X) carrier in new or existing spectrum. CDMA2000 1X is also known as IS-2000, MC-1X and IMT-CDMA MultiCarrier 1X and 1×RTT (Radio Transmission Technology). The interim standard in the United States is IS-95B, which provides data capabilities up to 64 Kbps integrated with voice.

CDMA2000 1×EV is an evolution of CDMA2000 that provides higher speeds on a single 1.25 MHz channel. CDMA2000 may also be deployed in a 5 MHz channel, which is three times (3X) the carrier rate of CDMA2000 1X. CDMA2000 3X is also known as MC-3X, IMT-CDMA MultiCarrier 3X and 3×RTT.

While implementing one or more of these proposed protocols may, at some point in time, enable the simultaneous transmission of voice and data, obtaining the required licenses and upgrading or retrofitting existing networks will take time and a significant investment. Additionally, in many of these proposed standards, the high bandwidth data capabilities exist at the expense of the low-bandwidth voice services, e.g., to obtain 100 Mbps of data capacity you lose almost 100 Mbps of voice capacity.

Additionally, the delay associated with obtaining bandwidth for data bursts in many of the protocols is relatively high, due mainly to theoretical limitations associated with the physical medium and practical limitations associated with protocol implementation. On the downlink side where codes are allocated in line with the negotiated bandwidth, the problem is somewhat more severe because of the limit to codes that can be allocated. These delays may be disconcerting to an user, especially where the delays are inconsistent or unpredictable. Accordingly, it would be advantageous to have a high data rate burst mode transmission capability at a predictable delay that could be interleaved with voice services, without seriously adversely affecting the network's voice capacity or performance.

### SUMMARY OF THE INVENTION

The present invention overcomes these and other drawbacks by enabling high bandwidth transmissions to take place over existing, second generation, wireless networks. According to one embodiment, an association is formed between two or more channels on one cellular terminal or on separate cellular terminals to identify, authenticate, and authorize high bandwidth traffic to either the cellular terminal or to an associated terminal, personal digital assistant (PDA), computer, or other communication device. This association may use the cellular frequencies themselves in a local communication mode or may involve an association between a signal in a cellular frequency and a signal formed using another technology. While the invention will be discussed as supplementing second generation wireless networks, it may also advantageously be implemented in connection with third, fourth or higher generation wireless networks, and the invention is not limited to an implementation on existing second generation networks.

Establishing an association between two or more channels enables traffic on the high bandwidth channel to be controlled by signals on a control channel. Signaling on the control channel may include requests, scheduling, reporting (time to wait for download, progress monitor), ARQs (automatic requests for resends), reporting availability of service, indicating cell activity, and managing traffic downloads during handoffs. Use of a control channel obviates the need to perform administrative functions on the high bandwidth channel, thus allowing the high bandwidth channel to be used wholly for data transmissions. The use of a control channel may be especially advantageous in connection with performing hand-offs (transfers of control from one cell to another) and coordinating transmission of data to user equipment network device(s) requesting access to the data channel over multiple data channels from adjoining cells.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a wireless communications network according to an embodiment of the invention;

FIG. 2 is a functional block diagram of a wireless communications network according to an embodiment of the invention;

FIGS. 3-5 are system level diagrams illustrating signal transmissions between functional units according to embodiments of the invention;

FIG. 6 is a timeline illustrating one possible channel allocation on a high bandwidth transmission channel according to an embodiment of the invention;

FIG. 7 is a flow chart of an example of software that may be used to implement embodiments of the invention;

FIG. 8 is a functional block diagram of an example of a bandwidth scheduler and resource proxy according to an embodiment of the invention; and

FIG. 9 is a functional block diagram of an example of a user equipment network device according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in greater detail below, the method and apparatus of the present invention enables stochastic (unknown before the event) processes to be handled separately from data transmission by forming an association between two or more wireless channels. In one embodiment, stochastic processes are handled separately from data transmission on a low-bandwidth control channel and this control channel is used to schedule access to a high-speed data channel. By using a low-bandwidth channel to handle stochastic processes, and scheduling data transmissions on the high-bandwidth data channel independent of the stochastic processes, the high-bandwidth data channel may be used more efficiently to avoid lost access slots due to scheduling conflicts.

The channel configured to handle the stochastic processes, in one embodiment, is formed as an overlay to a second-generation network and includes an “always on” shared low data rate channel, similar to a control channel or pager channel. This channel will be referred to herein as the “control channel,” although it may be used to transmit application data as well as perform the functions discussed herein.

This low data rate channel is associated with one or more high speed burst broadcast mode channels, which will be referred to herein as the “data channels.” Each data channel is divided into discrete code or time slots (referred to herein as access slots), that are unassigned to any particular recipient, user, or group of users until requested. In the event that a particular user requires a particular service, access slots are requested through the control channel, allocated to the user, and allocation information is passed back to the requesting user through the control channel. Broadcast information on the data channel is then filtered and decoded by the user using access information associated with the access slots to obtain the requested service.

The control channel can be used to disseminate access information to enable users to have common, select, or private, access to broadcast information. The information disseminated in this instance may be information indicating that certain data is freely available on the data channel in a particular access slot or range of access slots. Freely available information may include locality based push advertising, public information such as traffic reports, or any other information that may be of particular interest to wireless users. The advertising information may include coupons, may be geographically tailored such that particular wireless users are provided with access to advertisements that are geographically relevant to their present position, may include information about existing or available groupcast sessions, or any other form of information that is desirable to make available to an user.

If a modest level of security is desired and access is to be provided to a select group, the access information may also include access codes to enable only a particular group of users to have access to the broadcast information. This may be desirable, for example, where a particular user has requested to have access to information that is offered for an additional fee over the high-speed data channel, but which is otherwise not of sufficient value to justify expenditure of resources to encrypt and decrypt the information. Such broadcast information may include video clips, audio clips, and other information suitable for broadcast to a group of users.

If higher a higher level of security is required, such as for the exchange of private information, the access information may include encryption information to enable secure transmissions to be broadcast and understood by only intended users.

By diverting setup and control traffic to a low-bandwidth, always-on quasi real-time control channel, capacity on the data channel can be freed up to enable the high-speed channel to be dedicated to transmission of high-bandwidth traffic. Thus, the scarce high-bandwidth resources can be utilized to the full extent possible without requiring transmissions to stop to perform housekeeping functions between transmissions to individual users and avoids lost time slots due to scheduling conflicts.

The low-bandwidth control channel may be used to handle many different functions. For example, the low-bandwidth control channel may be used to identify, authenticate, and authorize high bandwidth traffic to either the cellular terminal or to an associated terminal, computer, PDA, or other communication device. The control channel may also be used to set expectations as to the onset and duration of a requested download. For example, the control channel may convey count-down information (transmission to commence in 10, 9, 8, . . . seconds) to the requesting user to enable the requesting user to anticipate onset of the requested download.

Signaling on the control channel may include requests for bandwidth allocation or requests for access to broadcast information, scheduling information used to schedule data downloads or uploads, reporting information used to report the status of an upcoming, occurring, or completed transmission, ARQs (automatic requests for resends), reporting availability of service, information indicative of the active cell, and managing downloads of traffic during handoffs. Use of a control channel obviates the need for handoff at the high bandwidth broadcast mode channel. Additionally, use of a control channel enables signals in the broadcast channel to be decoded (where appropriate) by more than one user.

Access slots may be assigned based on any particular algorithm to take into account the particular transmission policies in place on the wireless network. For example, time critical applications may be given priority over other types of applications. The invention is not limited to any particular manner of prioritizing access slots.

Control Channel

The quasi-always on low-bandwidth control channel may be implemented using any number of technologies. In one embodiment, the control channel is implemented as a cellular channel on a cellular network implemented according to any of the currently deployed wireless communications protocols, including but not limited to GSM, CDMA, or UMTS, or any future technologies.

The low-bandwidth control channel in this embodiment is configured to perform a number of Operation, Administration, and Maintenance/Control (OAM/Control) functions. Examples of OAM/Control functions that may be performed using the low band control channel include:

Allowing users to request wideband service;

Scheduling and managing wideband service;

Authenticating users, requests, or other information;

Distributing access and decryption codes;

Advising users of status of requests, download progress;

Allowing users to request resends of failed transmissions;

Allowing users to acknowledge successful downloads;

Monitoring cell location and requesting resends following cell handoffs;

Advising a requesting user of the cost associated with the requested service and other information associated with request;

Accepting and releasing the data channel;

Additional or alternative functions may be performed using the control channel as well, and the invention is not limited to using a control channel to perform some or all of these particular listed OAM/Control functions.

Data Channel

The high bandwidth data channel is formed as a broadband broadcast mode channel that simultaneously broadcasts a common signal to all users within the cell and optionally is also distributed to users in one or more other cells. This broadband broadcast mode may be implemented using any conventional wireless technology, having the ability to broadcast, multicast, or single cast data, including technologies designed to broadcast information in licensed spectra or in license exempt spectra.

In one embodiment, the high bandwidth data channel is implemented using Orthogonal Frequency Division Multiplexing (OFDM), a technique that transmits large amounts of digital data over a radio signal by splitting the radio signal into multiple smaller sub-signals that are then transmitted simultaneously at different frequencies to the receiver. In another embodiment, the high bandwidth data channel may be implemented using HiperLAN, a broadband wireless technology operating in the 5 GHz frequency band. The invention is not limited to any one of these particular embodiments, but rather encompasses transmission in the data channel on any appropriate bandwidth.

The data channel may be organized in any desired fashion. In one embodiment, the data channel is organized to have a mixture of dedicated access slots and burst mode access slots. The dedicated access slots, in this embodiment, are reserved to be used for time sensitive traffic such as telephony and video. The burst mode access slots are provided to accommodate traffic bursts associated with typical data traffic such as web browsing, file downloads, and other bursty traffic.

The high bandwidth data channel may be used for any number of applications. Wireless Virtual Private Networks (VPNs) may be established over the high bandwidth data channel. Standard data applications such as accessing the Internet, downloading private files, accessing e-mail messages, obtaining SMS messages or MMS messages, participating in video telephone calls, or receiving streaming audio or video, may also be implemented. Additionally, location based services by using time difference triangulation on the broadcast signal and uploading the result through the control channel, may be implemented on the embodiments of the invention. During periods of peak use, in one embodiment, the high bandwidth data channel may be used to transmit voice traffic as well to maximize the number of voice circuits on the wireless network. The invention is not limited to any particular technologies implemented for use over the high bandwidth wireless data channel.

As discussed above, the data channel may be used, in one embodiment, to disseminate access information to enable users to have common, select, or private, access to broadcast information. The access information may be transmitted individually to users, or multiple access codes addressed to multiple users may be identified to the users and transmitted together in a string. In operation, broadcast information such as video clips of sports events, news items, etc. may be groupcast on the data channel, and a select group of authorized users can access this groupcast information using access codes provided over the control channel. Private communications, which may include video teleconferencing, private file downloads, or optionally short duration video (video clips), can be encrypted and enabled in much the same way, such as by distributing a key to each mobile telecommunication unit requesting access to the private communications.

In the embodiments disclosed herein, the data channel has been described as transmitting high bandwidth data from a base transceiver station to an user equipment network device. The invention is not limited in this regard, however, as it may also be used to schedule transmission of high bandwidth data from the user equipment network device to one or more base transceiver station. Additionally, although the invention has been described as using a control channel to schedule transmissions on one high-bandwidth channel, the invention is not limited in this regard, as a control channel may be used to schedule transmissions on more than one high-bandwidth channel. For example, one high-speed channel may be used for transmissions from the user equipment network device to the base transceiver station, and another for transmissions from the base transceiver station to the user equipment network device. Accordingly, the invention is not limited to the embodiments set forth herein but rather extends to any such embodiment that associates a low-bandwidth wireless control channel with one or more high-bandwidth data transmission channels.

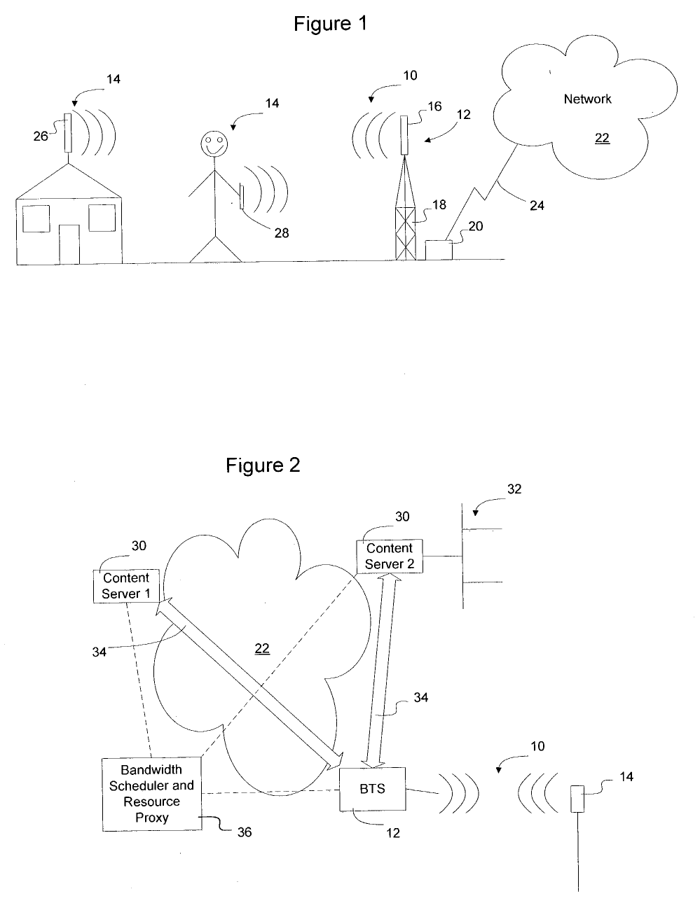

FIG. 1 illustrates one embodiment of a wireless communications network configured to implement embodiments of the invention. As illustrated in FIG. 1, a wireless network 10 is formed by transmitting signals between a base transceiver station (BTS) 12 and user equipment network devices (UEs) 14. The BTS 12 may include various equipment, such as an antenna 16 on a tower 18, and a network device 20 configured to perform functions associated with passing information between the wireless network 10 and other telecommunications networks 22 (such as the Internet). The BTS 12 may be linked with the telecommunications networks 22 via an optical, electrical, wireless, or other link 24.

User Equipment network device (UE) 14 may be associated with a fixed location 26, such as a wireless modem connected to a computer in a residence, or may be associated with a cellular telephone, PDA, or cellular link associated with a wireless modem in a computer 28. The invention is not limited to any particular UE, but rather extends to any UE configured to operate in accordance with the embodiments of the invention as set forth herein.

FIG. 2 illustrates a telecommunications network according to an embodiment of the invention including a BTS 12 configured to communicate over a wireless network 10 with one or more UEs 14. As shown in FIG. 2, the telecommunications network 22 may include one or more content servers 30 that may contain resources or have access to resources over other public or private networks 32.

The content servers 30 may be connected to the BTS through ordinary paths through the public network 22, or, optionally, may be connected to the BTS through virtual private network tunnels 34 set up in any conventional manner, such as via encapsulation or encryption. The invention is not limited to any particular manner of establishing a connection between the content servers 30 and the BTS 12.

A bandwidth scheduler and resource proxy 36, according to embodiments of the invention, is configured to manage end-to-end communication of data to and from the UE, taking into account layers 1 through 7 of the OSI model, to create a constant delay function attendant with requesting and receiving data over the wireless network. This enables data replies to be received by the requesting UE in a reliable and expected manner to facilitate anticipatory precacheing of data and to enable management of customer expectations. In one embodiment, the resource proxy 36 is configured to receive resource requests, allocate bandwidth on a high-bandwidth data channel on the wireless network 10, and coordinate delivery of data from the content servers 30 to the UE 14 through the BTS. Optionally, the bandwidth scheduler and resource proxy may perform additional functions attendant to delivery of the data, such as encrypting the data and/or compressing the data prior to transmission.

As discussed in greater detail below, the bandwidth scheduler and resource proxy 36 may be formed as one network device, as separate network devices, may be instantiated as one or more processes running on a network device on the public network 22, or may be instantiated as one or more processes running on the BTS. In one embodiment, the bandwidth scheduler and resource proxy is formed as a separate network device serving multiple BTSs. In other embodiments, the bandwidth scheduler and resource proxy is formed as a process instantiated on the public network and serving only a single BTS. The invention is not limited to the location of the bandwidth scheduler and resource proxy on the public network 22.

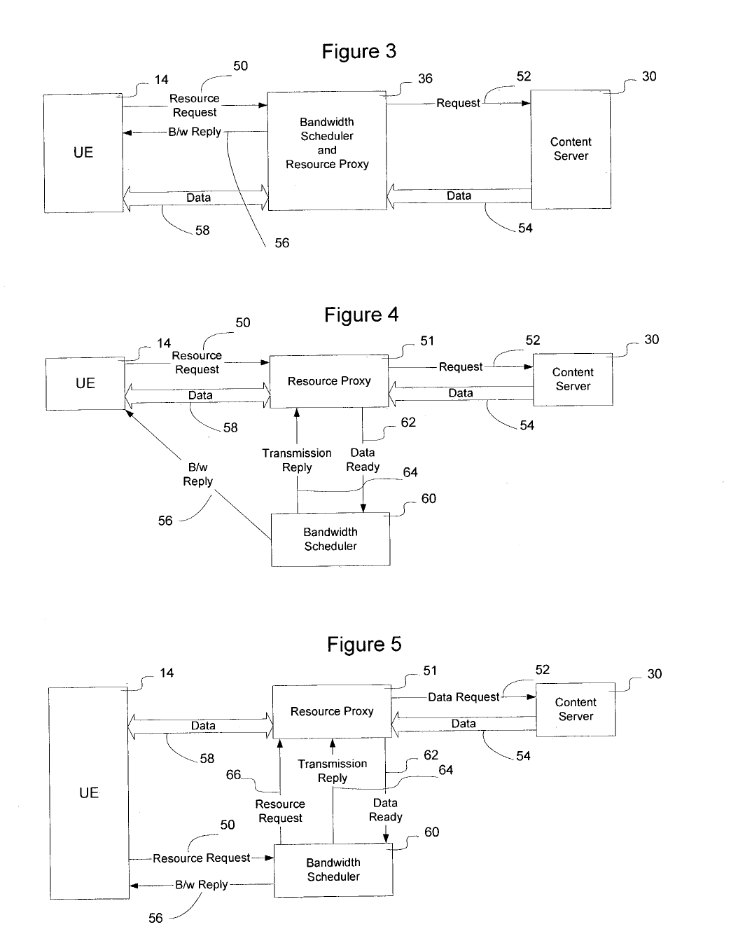

FIGS. 3-5 illustrate several possible ways to implement a resource proxy and bandwidth scheduler according to embodiments of the invention. The invention is not limited to these three illustrated embodiments, but rather extends to all possible permutations. In the embodiments illustrated in FIGS. 3-5, the bandwidth scheduler and resource proxy is configured to receive one or more requests for resources and/or bandwidth from an UE over a low-bandwidth control channel, obtain the requested resource (if necessary), and coordinate access to bandwidth and/or delivery of the requested resource to the UE over the high-bandwidth data channel. Where data is sought to be transmitted by the UE, the bandwidth scheduler and resource proxy may not need to obtain any resource, but may need to coordinate via established protocols for one or more other network devices to receive the data upon transmission. While the invention will be described herein as illustrating transmission of data from the BTS to the UE, the invention is not limited in this regard as illustrated by the two-ended arrow 58 illustrating the flow of data as proceeding in both directions between the UE and BTS. Similarly, although only a single UE has been illustrated for simplicity, in an operational setting more than one UE may be requesting access to data and, as described above, the same data may be accessed by more than one UE at the same time. Thus, the invention is not limited to a single UE obtaining access to the broadcast data.

FIG. 3 illustrates an embodiment of the invention in which the bandwidth scheduler and resource proxy are instantiated in the same network device as either a single process or as an integrated process. As shown in FIG. 3, upon ascertaining a need for a resource, the UE 14 transmits a resource request 50 to the bandwidth scheduler and resource proxy 36 over a control channel as discussed in greater detail above.

Upon receipt of the resource request, the bandwidth scheduler and resource proxy 36 ascertains whether there is sufficient bandwidth to accommodate the requested transmission. If there is insufficient bandwidth on the high speed data channel, the bandwidth scheduler and resource proxy 36 will transmit a request denied signal to the UE14. If there is sufficient bandwidth available on the high bandwidth data channel, the bandwidth scheduler and resource proxy 36 transmits a request for the resource 52 over the public network to an appropriate content server 30 using established protocols and known methods. Optionally, the bandwidth scheduler and resource proxy 36 may acknowledge receipt of the request over the low-bandwidth control channel as well.

Upon receipt of the resource 54 from the content server 30, the bandwidth scheduler and resource proxy 36 allocates bandwidth on the high speed data channel and communicates the bandwidth allocation 56 to the UE 14. The bandwidth allocation (B/w reply 56) may take many forms, depending on the type of resource requested. For example, where the requested resource is a time-sensitive long duration data application, such as a video telephony application, the B/w reply 56 may include information indicative of a recurring access code or recurring access slot. Where the requested resource is a burst of data to be downloaded, the B/w reply 56 may include information indicative of one or more allocated access slots. Optionally, the B/w reply may include synchronization information to enable the UE 14 and BTS 12 to be synchronized just prior to transmission of the data over the high speed data channel.

After transmitting the B/w reply 56 containing access information instructive of when and how to access information on the data channel, the bandwidth scheduler and resource proxy 36 will cause the resource to be transmitted to the UE over the allocated access slots on the high speed data channel 58. Optionally, the UE14 and bandwidth scheduler and resource proxy 36 may communicate additional status, failure, completion, or other messages over the control channel prior, during, or after transmission of the requested data 58 over the high speed data channel.

FIG. 4 illustrates an embodiment in which the UE transmits a request for a resource over the control channel, and in which the resource proxy and bandwidth scheduler are instantiated as different processes on the same device or on different devices. As shown in FIG. 4, upon ascertaining a need for access to a resource, the UE 14 transmits a resource request via a low-bandwidth control channel to the resource proxy 51.

The resource proxy, upon receiving a request for a resource, will format and transmit a request over the public network 52 and wait for a response containing the data 54. Optionally, the resource proxy may also exchange information with the bandwidth scheduler to inform the bandwidth scheduler that the resource proxy is likely to request data soon, and to ascertain whether there is likely to be bandwidth available on the high speed data channel. The resource proxy may also communicate with the UE to advise the UE on the status of the request.

Upon receipt of the data 54, the resource proxy 51 requests bandwidth from the bandwidth scheduler 60 by passing a data ready request 62 indicating the size of the data to be transmitted and any other pertinent information, such as the priority of the data and the likely duration of the data stream if the data is not a single burst. The bandwidth scheduler 60 allocates bandwidth on the high speed data channel, and transmits the bandwidth allocation to the UE 14 via a bandwidth reply message 56. The bandwidth scheduler also transmits the bandwidth allocation to the resource proxy 50 via a transmission reply message 64 indicating to the resource proxy when to transmit the resource to the requesting UE. Optionally, the bandwidth reply message 56 may be generated by the resource proxy 51 instead of the bandwidth scheduler 60 to allow the UE to have a single point of contact for the resource on the network.

FIG. 5 illustrates another embodiment in which the UE transmits a request for a resource over the control channel, and in which the resource proxy and bandwidth scheduler are instantiated as different processes on the same device or on different devices. In this embodiment, communication with the UE over the low-bandwidth control channel is handled by the bandwidth scheduler 60.

As shown in FIG. 5, upon receipt of a resource request 50, the bandwidth scheduler passes the resource request to the resource proxy 51 via a resource request message 66. The resource proxy requests the data 52 from the content server 30 and receives the data 54. Upon receipt of the requested resource, the resource proxy notifies 62 the bandwidth scheduler 60 that the resource is available for transmission. The bandwidth scheduler allocates bandwidth on the data channel and notifies the resource proxy 51 of the allocation via a transmission reply message 64, and notifies the UE 14 of the allocation via a bandwidth reply message 56. In the designated access slot(s) the resource proxy 51 transmits 58 the requested resource to the UE.

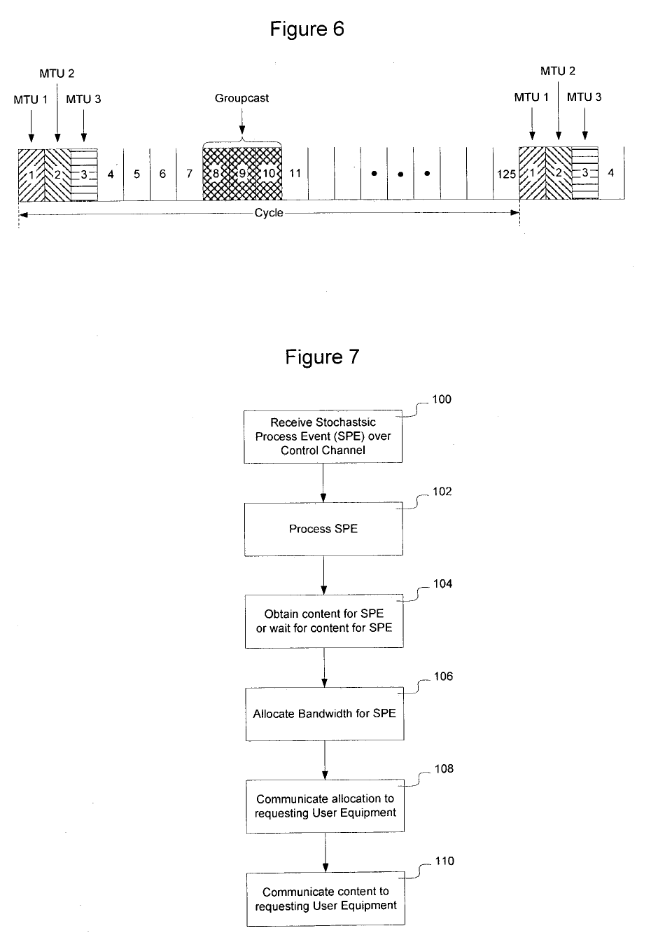

FIG. 6 illustrates one example of several possible ways of allocating access slots on the high bandwidth data channel. The access slots in FIG. 6 may be time slots or may be code slots. For ease of illustration, FIG. 6 illustrates the access slots as time slots in a cyclical physical layer protocol. The invention is not limited to the particular illustrated allocation.

As illustrated in FIG. 6, the access slots in the data channel may be allocated in any number of different manners. For example, as shown in FIG. 6, some of the access slots (e.g. slots 1-3) may be allocated to UEs requiring recurring access to the high speed data channel, for example to participate in video telephony or other regularly recurring bandwidth intensive applications. Other access slots (e.g. slots 8-10) may be used to transmit multicast information, the access codes to which have been previously distributed via the control channel to MTUs wishing to participate in the multicast session. Other access slots (e.g. slots 4-7 and 11-125) may be allocated to UEs on an as-needed basis to accommodate data bursts to the specified UEs. The invention is not limited to transmission of these three particular types of traffic over the high bandwidth data channel, but rather extends to all potential uses of the high bandwidth data channel.

FIG. 7 illustrates a flow chart of software that may be used to implement embodiments of the invention. In the embodiment illustrated in FIG. 7, stochastic process events are handled over the control channel to allow bandwidth on the data channel to be allocated efficiently. As shown in FIG. 7, upon receipt of a stochastic process event 100, such as a request for a resource, the network device will process the stochastic process event 102 and obtain the content or wait for the content to arrive for transmission over the high speed data channel 104.

Concurrent or subsequent with obtaining access to the requested resource, the network device will allocate bandwidth on the high bandwidth data channel 106 to accommodate the requested resource. The network device will also communicate the allocation 108 to the requesting mobile telecommunications unit and, in the allocated access slots, communicate the content to the requesting mobile telecommunications unit 110.

### EXAMPLES

A series of examples may help to explain the operation of the invention. The following examples are not meant to limit the invention but rather to explain the principles of operation in potential real-life situations. Accordingly, the invention is not limited to any particular set of circumstances in the following examples.

### Example 1

Downloading File

Assume, in this example, that an user wishes to download a resource from the Internet, such as a file stored on a server on the Internet. The user, in this example, sends a request via the control channel to the bandwidth scheduler and resource proxy requesting the file. The bandwidth scheduler and resource proxy obtains the file, determines the size of the file, the transmission priority, and class of service. The bandwidth scheduler and resource proxy then allocates time slots on the data channel to place the file in line for transmission to the requesting user.

The bandwidth scheduler and resource proxy advises the user, on the control channel, of the amount of delay before the download will commence, the download duration, and other pertinent information, such as the cost of the download, and optionally may provide the user with the ability to confirm or cancel the download. Once the download has commenced, the bandwidth scheduler and resource proxy confirms the commencement with the requesting network device via the control channel. The control channel is then used to acknowledge receipt of the file by the requesting network device or to request retransmission in the event of a failure.

### Example 2

Video Telephony

Assume, in this example, that a wireless user wishes to initiate a video telephone call (either one way or bi-directional). In this instance, using embodiments of the present invention, the user communicates its request to the bandwidth scheduler and resource proxy via the control channel. The bandwidth scheduler and resource proxy checks the availability of the data channel. If the data channel is not available, it will notify the requesting network device via the control channel that it is not possible to make a video telephone call at this time. If the data channel is available, the bandwidth scheduler and resource proxy will allocate sufficient time slots indefinitely on a one-out-of-every-n basis. The bandwidth scheduler and resource proxy will then communicate information sufficient to enable the video call to be set up via the control channel.

### Example 3

Groupcast

Assume, in this example, that the user would like to receive groupcast information made available to a group of users through the wireless network. The groupcast information may be any commonly available groupcast information, such as streaming video, streaming audio, sports scores, news items, stock quotes, or other text-based information, or other types of media suitable to be broadcast to a group of recipients.

In this example, the requesting network device will send a request to join or initiate a groupcast session to the bandwidth scheduler and resource proxy via the control channel. The bandwidth scheduler will check to see if there is a groupcast session matching the request already in place on the data channel. If the groupcast session exists, the bandwidth scheduler and resource proxy will respond to the requesting network device via the control channel with sufficient information to enable the requesting network device to join the groupcast session. If the groupcast session is not being broadcast or queued to be broadcast on the data channel when the scheduler receives the request to join the groupcast session, the bandwidth scheduler and resource proxy will check to see whether there is sufficient bandwidth on the data channel to accommodate the request. If there is, the bandwidth scheduler and resource proxy will allocate time slots to the groupcast session and will respond to the requesting network device with sufficient information to enable the requesting network device to receive the requested groupcast information. If, however, there is insufficient bandwidth to accommodate the request, the denial of service will be communicated back to the requesting network device via the control channel.

Information associated with an affirmative response to the request to join a groupcast session may include when the groupcast session will commence, the duration of the groupcast session (if the groupcast session is of a predetermined duration), the access slots during which the groupcast session will be broadcast, access code(s) and/or decryption code(s) to enable the network device to have access to and, optionally, to decrypt the groupcast information, and any other pertinent information.

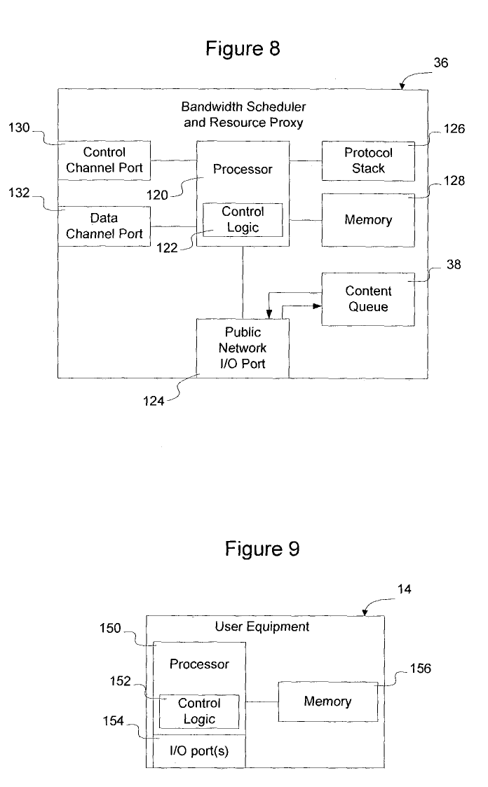

FIG. 8 illustrates one embodiment of a bandwidth scheduler and resource proxy 36 according to an embodiment of the invention. As illustrated in FIG. 8, a bandwidth scheduler and resource proxy contains a processor 120 having control logic 122 configured to implement the functions ascribed to it as described above in connection with FIGS. 1-7. The bandwidth scheduler and resource proxy also includes public network I/O ports 124 configured to enable it to communicate data received over the data channel and requests for resources received over the control channel onto the public network 22, and receive information from the public network. Interactions with the public network 22 may be facilitated through the implementation of a protocol stack 126 containing instructions and data relevant to communications protocols commonly used on the public network.

A content queue 128 is provided to temporarily store resources returned in response to requests passed onto the public network. Optionally, the content queue may retain resources in the queue 128 until overwritten by other requests to enable the network device to more quickly respond to commonly recurring requests. A memory 129, formed separate from the content queue 128 or forming a part of content queue 128, contains data and/or instructions for use by the control logic to enable it to perform the functions required of it to participate in communicating over the control channel and data channel.

One or more I/O ports 130, 132 are provided to enable the bandwidth scheduler and resource proxy 36 to send and receive signals from the wireless network. Specifically, in the illustrated embodiment, the bandwidth scheduler and resource proxy 36 includes a control channel port 130 configured to receive and transmit information over the control channel, and a data channel port 132 configured to receive and transmit information over the data channel. In the illustrated embodiment only two I/O ports have been illustrated to prevent obfuscation of the inventive aspects of the invention. The invention is not limited to a network device having two I/O port or a single pair of I/O ports, as a network device may have any number of I/O ports.

FIG. 9 illustrates one embodiment of a user equipment network device (UE) configured to implement embodiments of the invention. The UE of FIG. 9 may be configured as a conventional GPRS/CDMA2000/UMTS phone, a phone link associated with a laptop carrying a PCMCIA modem, a PDA, or any other wireless data processing unit.

As illustrated in FIG. 9, an UE 14 contains a processor 150 having control logic 152 configured to implement the functions ascribed to it as described above in connection with FIGS. 1-7. The UE also includes I/O ports 154 configured to enable it to communicate requests for resources onto the control channel and receive results over the data channel. A memory is provided, in this embodiment, containing instructions and data relevant to communications protocols and containing data and/or instructions for use by the control logic to enable it to perform the functions required of it to participate in communicating over the control channel and data channel. In one embodiment, the UE is configured such that the high bandwidth receiver is only activated for slots intended for that user to conserve power and extend the battery life of the UE, although the invention is not limited in this regard. Determining when to turn on to access the data may be performed in coordination with synchronization information received over the data or control channel, or in connection with estimated time delays associated with requesting and obtaining information over the data channel.

The control logic 122, 152 may be implemented as a set of program instructions that are stored in a computer readable memory within the network device and executed on a microprocessor within the network device. However, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of facilitating transmission of data over a wireless network, the method comprising the steps of:
receiving a resource request via a first channel; and
allocating bandwidth on a second channel in response to said resource request.

2. The method of claim 1, wherein the resource request is a request to download data to a mobile telecommunications unit, and wherein the step of allocating bandwidth comprises allocating access slots on the second channel.

3. The method of claim 1, wherein the resource request is a request to join a multicast group and the step of allocating bandwidth comprises providing access information to enable access to the multicast group.

4. The method of claim 1, wherein the request for data access to the wireless network is received from a network device, and wherein the method further comprises the step of communicating a result of the step of allocating bandwidth to the network device.

5. The method of claim 4, wherein the first channel is a wireless communications channel, and wherein the second channel is a RF channel.

6. The method of claim 1, further comprising the step of:
requesting a resource from a content server in response to the resource request.

7. The method of claim 6, further comprising the step of:
receiving the resource; and
transmitting the resource in the allocated bandwidth on the second channel.

8. The method of claim 1 wherein the first channel has a first bandwidth, the second channel has a second bandwidth, and wherein the first bandwidth is much smaller than the second bandwidth.

9. A network device, comprising:
control logic configured to:
receive a resource request on a first channel; and
allocate bandwidth on a second channel in response to said resource request.

10. The network device of claim 9, wherein the control logic is further configured to request a resource from a content server in response to the resource request.

11. The network device of claim 10, wherein the control logic is further configured to receive the resource and transmit the resource in the allocated bandwidth on the second channel.

12. The network device of claim 11, further comprising a content queue configured to store the received resource prior to transmitting the resource in the allocated bandwidth on the second channel.

13. The network device of claim 12, wherein the content queue is configured to store information until overwritten by other data to enable the network device to have rapid access to recently requested resources.

14. The network device of claim 10, further comprising a first low-bandwidth input/output port configured to be connected to the first channel, a second high bandwidth input/output port configured to be connected to the second channel, and a public network input/output port configured to access a network having access to at least one content server.

15. A mobile telecommunications unit, comprising:
control logic configured to:
request access to a resource on a control channel;
receive instructions via the control channel regarding access to the resource on a data channel; and
receive the resource on the data channel.

16. The mobile telecommunications unit of claim 15, further comprising:
input/output ports configured to enable access to the first channel and the second channel.

17. The mobile telecommunications unit of claim 16, wherein the input/output port configured to enable access to the second channel is configured to be enabled only to receive the resource on the data channel.
